(19) United States
(12) Patent Application Publication
(10) Pub. No.: US 2004/0064315 A1
(43) Pub. Date: Apr. 1, 2004

(54) Acoustic confidence driven front-end preprocessing for speech recognition in adverse environments

(76) Inventors: Michael E. Deisher, Hillsboro, OR (US); Sangita Sharma, Portland, OR (US)

Correspondence Address: Robert A. Burtzlaff, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/262,297

(22) Filed: Sep. 30, 2002

(51) Int. Cl. G10L 15/20

(52) U.S. Cl. 704/233

(57) ABSTRACT

A speech processing method that improves overall speech recognition accuracy uses a digital speech signal pre-processing to reduce noise using a noise mitigation algorithm having defined parameters. The digital speech signal is analyzed with a ASR decoder that provides decoder scores; acoustic-unit confidence is determined given the ASR decoder scores; and the noise mitigation algorithm is modified based on the computed acoustic unit confidence.

### FIELD OF THE INVENTION

The present invention relates to automatic speech recognition systems. More particularly, the present invention relates to improved acoustic preprocessing for speech recognition in adverse environments.

### BACKGROUND

Reducing speech recognition error rates is of special interest for applications using mobile cell phones, office telephone handsets, microphone equipped digital dictation devices, and multimedia personal computers and laptops. Advanced computer user interface systems supporting even rudimentary speech recognition capability can be augmented if the system is capable of reliably and automatically operating when environmental noise significantly decreases clarity of the received speech signal.

Speech recognition error rates are noticeably higher in acoustically noisy environments with currently available techniques. Background noise is a common problem for Automatic Speech Recognition (ASR) systems, causing substantial performance degradation. The degradation is mainly caused by the mismatch of the acoustic characteristics between the training and test data. One approach to reducing the mismatch is to simply retrain the ASR system under the test environment. This method, however, works only if the test environment is known and remains constant. There are many situations (e.g., in mobile applications) where the acoustic environment is changing and unpredictable, and thus it is not possible to retrain the ASR system. Another approach to addressing the mismatch issue is to pre-process the noisy speech signal using Noise Mitigation (NM) algorithms such that the pre-processed speech more closely matches the acoustic models trained on noise-free speech. This approach, when achievable, is more practical than the retraining method in solving mismatch problem. Even when NM algorithms fail to produce speech that matches the clean acoustic models, they often produce speech that whose statistics vary significantly less than unprocessed speech across a range of acoustic environments. Therefore, it is often necessary to retrain only once when an NM algorithm is introduced.

Various noise mitigation techniques are currently employed, ranging from simple elimination of a signal prior to analysis to schemes for adaptive estimation of the noise spectrum that depend on a correct discrimination between speech and non-speech signals. Unfortunately, the more complex schemes can be quite complex, requiring noise mitigation algorithms that are painstakingly tuned using speech collected from many different acoustic environments.

### BRIEF DESCRIPTION OF THE DRAWINGS

The inventions will be understood more fully from the detailed description given below and from the accompanying drawings of embodiments of the inventions which, however, should not be taken to limit the inventions to the specific embodiments described, but are for explanation and understanding only.

FIG. 1 schematically illustrates a speech recognition process that includes modifying noise mitigation algorithms/parameters in response to downstream signal processing;

FIG. 2 illustrates one embodiment of a speech recognition system having an ASR decoder and a post processing unit that provides information for automatic modification of a noise mitigation preprocessing unit;

FIG. 3 shows schematically the operation of the noise mitigation preprocessing unit; and

FIG. 4 shows schematically the operation of one embodiment of an acoustic sampling unit.

### DETAILED DESCRIPTION OF THE INVENTION

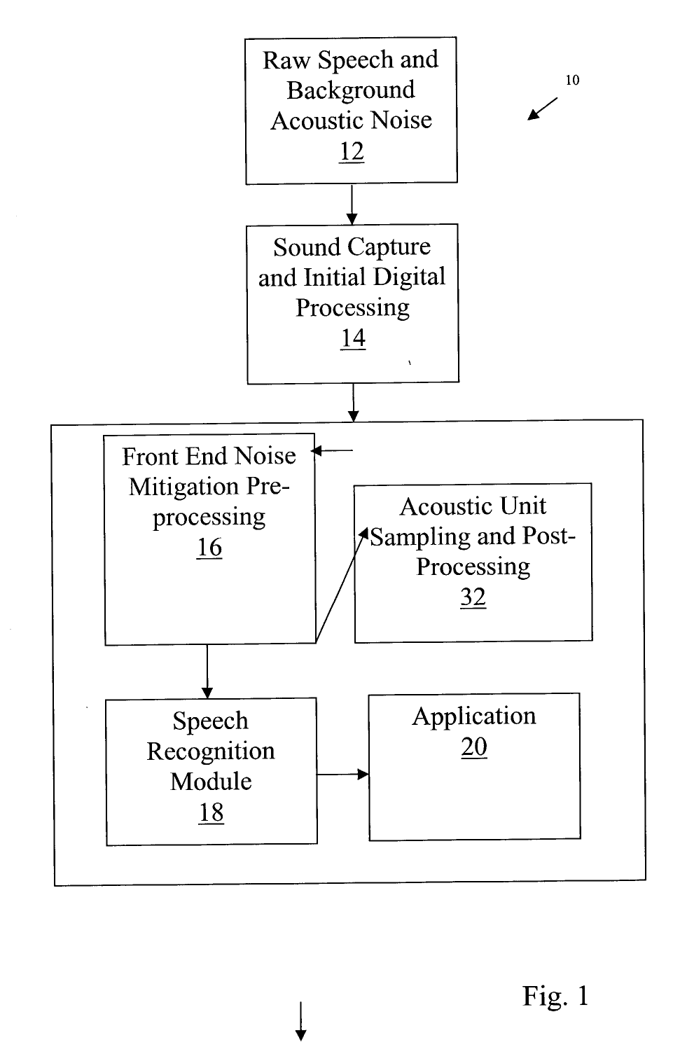

As seen with respect to FIG. 1, an automatic speech recognition system 10 analyzes raw speech and background noise input 12 as captured and digitized by a sound capture apparatus and initial digital processing module 14. Typically, the module 14 includes a microphone system that provides an analog electrical output representative of the sound, which is digitized by a suitable analog to digital converter. Either the analog or digital signal can be initially cleaned and processed to remove high or low frequency components, burst or static noise, or other unwanted noise that may interfere with the desired speech signal. As will be appreciated, the captured sound signal can be immediately analyzed by the automatic speech recognition system 10, or stored in a suitable analog or digital form for later analysis.

The automatic speech recognition system 10 includes a module 16 for front end noise mitigation processing, and an speech recognition module 18 that accepts input from the module 16 and generates a speech transcription that is passed to a speech driven application 20. The application can be a user interface to a computer operating system, a word processing dictation application, a robotic control system, a home or workplace automation system, a phone messaging system, or any other suitable system that benefits from primary or auxiliary speech input.

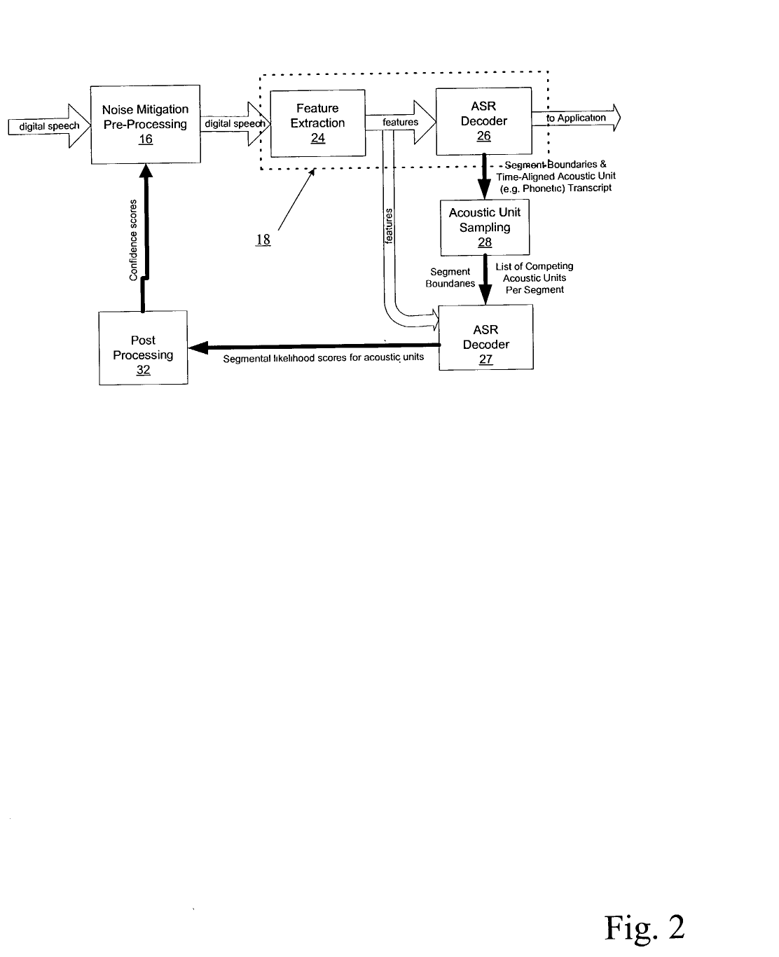

As seen with respect to FIG. 2, the module 18 for speech recognition can include a feature extraction module 24 and an ASR decoder 26. The function of the ASR decoder 26 is to find the most probable sequence of words given the sequence of feature vectors, the acoustic model (e.g. hidden Markov Model, Bayesian networks, etc.) and the language model. As will be understood, various decoding techniques can be employed by ASR decoder 26, including but not limited to techniques based on the Viterbi algorithm. Viterbi decoding is a forward dynamic programming algorithm that searches the state space for the most likely state sequence that best describes the input signal. Alternatively, another example of decoding technique used with hidden Markov models is the Stack Decoding technique that is a best-first algorithm that maintains a stack of partial hypotheses sorted based on their likelihood scores and at each step the best hypothesis is popped off the stack. Unlike Viterbi decoding this technique is time-asynchronous, i.e., the best scoring path or hypothesis, irrespective of time, is chosen for extension and this process is continued until a complete hypothesis is determined.

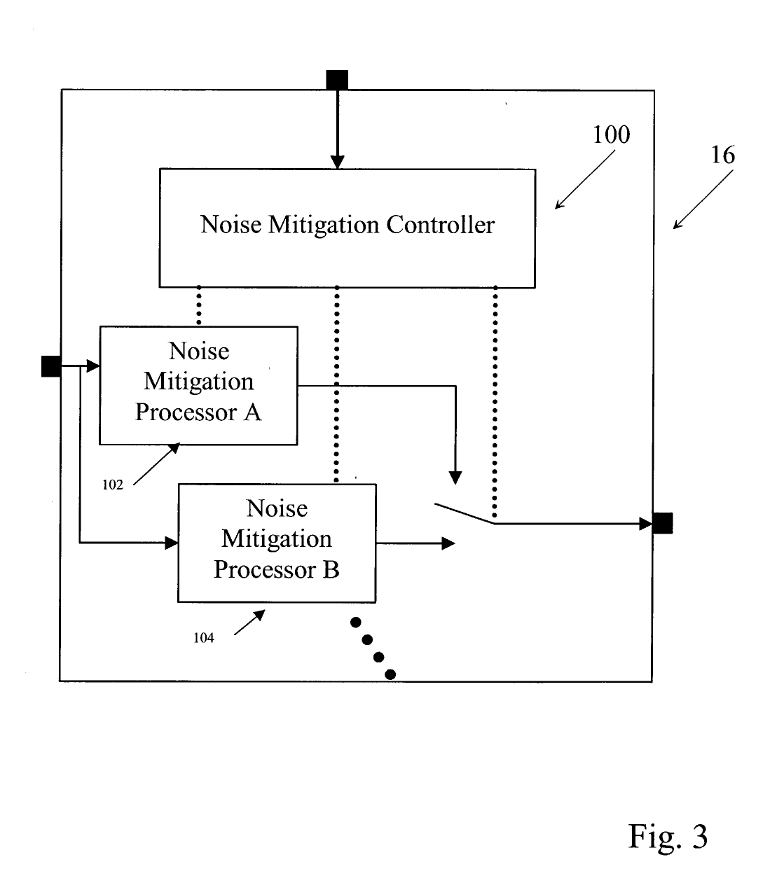

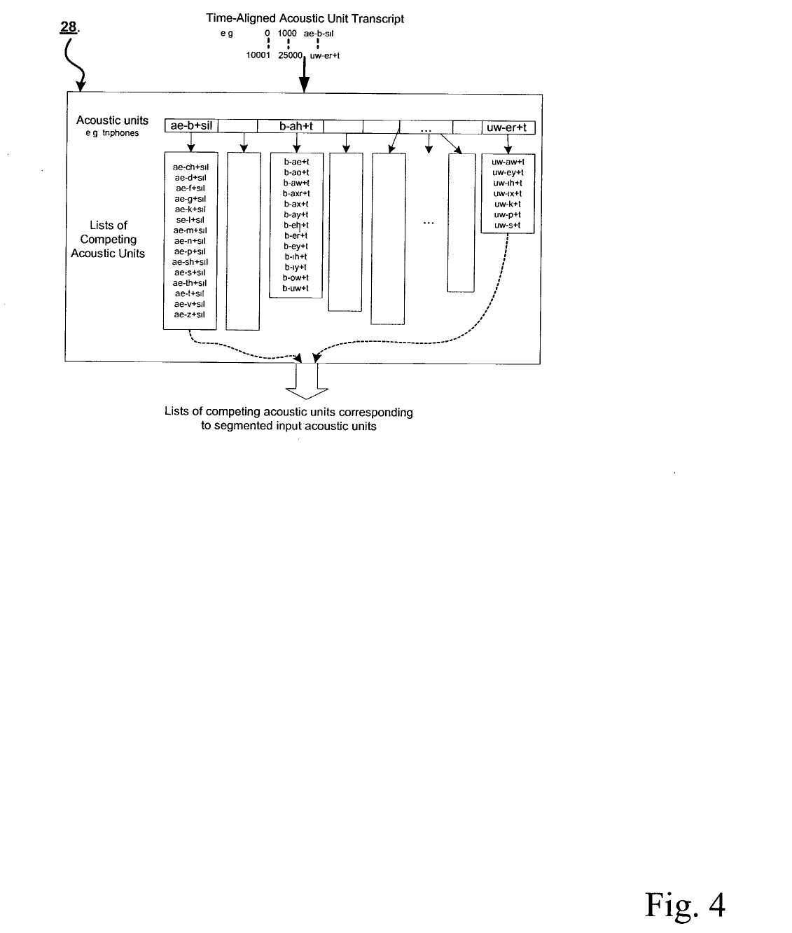

The feature extraction module 24 accepts blocks of digital speech samples and transforms each one into a low-dimensional representation called a feature vector that preserves information relevant to the recognition task and discards irrelevant portions of the signal. The ASR decoder 26 accepts a sequence of feature vectors and produces word string that satisfies

$${W}^{opt} = {arg max}_{W} P ( W \vert λ ) {max}_{X} P ( Y \vert X , λ ) P ( X \vert W , λ )$$

where W=w₁w₂ . . . w_{Nw} is a sequence of N_{w} words, Y=y₁y₂ . . . Y_{Ny} is a sequence of N_{y} feature vectors, X=x₁x₂ . . . x_{Ny} is a sequence of N_{y} hidden Markov model states, and λ is a hidden Markov model. (Note that although an HMM is used as an example here, the method of this invention applies to other state-based statistical models of speech such as Bayesian networks). P(W|λ) represents the word prior probabilities, also known as the language model. In addition to the word string, the most likely state sequence X^{opt} is also produced by the ASR decoder 26. Since the association of HMM states to acoustic-units (e.g., phonemes) is known, it is straightforward to derive the sequence of acoustic-units chosen by the recognizer from X^{opt}. This sequence may be reformatted as a time-aligned acoustic unit (e.g., phonetic) transcript that clearly delineates acoustic unit boundaries. Note that this invention does not modify the operation of the ASR decoder 26 in any way. It simply makes use of information that may be derived from its output. The acoustic unit sampling module 28 derives the time-aligned acoustic unit transcript from the optimal state sequence X^{opt} and generates lists of competing acoustic-units for each segment. The utility of these lists is described below in the description of FIG. 4. The ASR decoder (shown as block 27 in FIG. 2) is activated a second time. However, this time the segments of the feature vector sequence (as defined by the time-aligned acoustic unit transcript) are submitted to the ASR decoder one at a time with word prior probabilities all set to one (i.e., with the language model disabled) and with only a subset of the HMM available. In other words, the ASR decoder finds the state sequence that satisfies

$${φ}_{j} ( {Y}_{n} ) = {max}_{X} P ( {Y}_{n} \vert X , {λ}_{j} )$$

where Yₙ=yₜ₍ₙ₎yₜ₍ₙ₎₊₁ . . . y_{t(n)+dn-1} is the sub-sequence of feature vectors corresponding to the n^{th} acoustic unit in the word string generated by the first decoding, t(n) is the starting frame index of the n^{th} acoustic unit, dₙ is the segment length, λⱼ is a subset of the speech model parameters representing only the j^{th} acoustic unit, and φⱼ(Yₙ) is the likelihood of the state sequence for the j^{th} acoustic unit. For each segment, acoustic unit sampling module 28 determines how many times the ASR decoder is run and which λⱼ's are active. The post-processing module 32 accepts the raw scores φⱼ(Yₙ) from the ASR decoder 27 and calculates confidence scores as described below in the discussion of FIG. 3. These confidence scores are provided as feedback to the noise mitigation processing unit 16 to allow modification of various parameters of the noise mitigation algorithm, or in certain cases, actual substitution or modification of the noise mitigation algorithm used in the unit 16. Minimally processed, digitally stored or near realtime speech processed by module 16 to remove noise, is further processed by module 18 and text is output to a speech-enabled application 20.

The noise mitigation pre-processing unit 16 is shown in more detail in FIG. 3. In this figure dashed lines are used to indicate control information flow and solid lines are used to indicate data and flow The noise mitigation pre-processing unit 16 receives an input digital speech signal and minimum, maximum, and average confidence scores from the post processing module 28. The confidence scores are reported for each hypothesized phonetic category in the utterance. They are used by the noise mitigation controller 100, noise mitigation processor A 102, and noise mitigation processor B 104 to adaptively modify noise mitigation algorithm parameters, choose between sets of pre-defined parameters, or choose between different algorithms. For example, for the class of speech estimators that includes spectral subtraction, Wiener filtering, Ephraim-Malah noise suppression, etc., a noise floor estimator is employed that makes certain assumptions about the stationarity of the background noise with respect to the speech. Most noise floor estimators have a parameter that controls how fast the noise model adapts. A very fast adapting noise model can track noise more accurately (and hence better remove it) but is susceptible to speech leaking into the estimate and corrupting the noise model. For low energy speech (such as unvoiced stopped consonants), this can result in severe attenuation of the speech by the noise mitigation algorithm and, consequently, mis-recognition by the recognizer. In effect, the ASR decoder/post processing module inform the noise mitigation algorithm, for example, when the scores of stop consonants drop significantly. This allows the noise mitigation algorithm to, for example, decrease the rate of noise model adaptation.

As another example, consider the case of two noise mitigation algorithms, one that performs well at modest noise levels (e.g. noise mitigation processor A 102) but is not robust to high noise levels, and one that is robust to high noise levels (e.g. noise mitigation processor B 104) but performs worse at modest noise levels. The noise mitigation controller 100 may choose to employ the latter whenever the confidence scores of low-energy speech sounds (e.g., fricatives) drops below a threshold.

Finally, consider the case where a state-based speech estimator (e.g., that of Y. Ephraim, “On the Application of Hidden Markov Models for Enhancing Noisy Speech”, IEEE Trans. ASSP, Vol. 37, No. 12, December 1989, pp. 1846-1856) is employed as the noise mitigation algorithm. Based on confidence scores, the noise mitigation controller 100 can identify precisely the noise mitigation pre-processor state that is underperforming and can signal the noise mitigation pre-processor to adapt the models for that state or, in soft-decision implementations, de-emphasize that state.

During the second decoding operation, the input to the ASR decoder 27 (which functionally is identical to ASR decoder 26) of module 16 is governed by an acoustic sampling unit 28 that decreases the computational load. ASR decoders typically model speech in terms of triphone acoustic-units, which number around 10,000 triphones in typical US English acoustic models. For a given segment of speech, confidence scoring as performed by the post-processing module 32 may involve computation of likelihood score for the triphone identified during the first decoding operation as well as the likelihood scores for all 9,999 or more competing triphones. Since segments are examined independently, traditional pruning methods are not applicable. Since there is a practical implementation limit based on the number of computations involved when scores for all the acoustic-units are computed, only the correct triphone and a subset of the competing triphones is used. If the subset yielding meaningful results is not too large, the acoustic-unit confidence scores can be computed efficiently. The triphone candidate subset for each of the triphones must be specified in advance to the decoder. The purpose of the acoustic unit sampling module 28 is to select a suitable subset for a given acoustic unit. Zero or more candidates must be specified for each triphone. Linguistic knowledge can be applied to choose competing triphone candidates that are likely to lead misrecognition of words. This approach is flexible enough to allow for scoring across arbitrary triphone classes. For example, in the case of the two classes, vowel and non-vowel, the triphone candidate list must be constructed such that, for each triphone belonging to the vowel class, candidates are taken from the non-vowel class only (and vice-versa).

FIG. 4 illustrates the operation of the acoustic unit sampling module 28 when lists of competing acoustic-units (in this example triphones, although senones, visemes, etc. can also be used when appropriate) are constructed such that the competing triphones all share the same right and left context. Here, the time-aligned acoustic unit transcript contains the triphone sequence ae−b+sil, . . . , uw−er+t. For the first segment, the acoustic unit sampling module 28 selects a previously defined list containing only 15 triphones (ae−ch+sil, ae−d+sil, etc.) as the subset to use when calculating confidence scores for the first segment. During the second decoding of the first segment, only 16 models need to be loaded by the decoder instead of approximately 10,000. Only 16 likelihood scores need to be calculated to find the confidence score. The acoustic sampling module 28 performs similar subset selections for the remaining segments of the utterance.

The post processing module 32 of the system 10 computes acoustic-unit (e.g., phoneme) confidence given the ASR decoder scores obtained during the second decoding. The acoustic-unit confidence is computed with reference to a known acoustic-unit transcript (obtained from the first decoding). The confidence score for segment n with respect to acoustic-unit j is

$$c o n {f}_{j} ( n ) = \frac{1}{{d}_{n}} log \{ \frac{{φ}_{j} ( {Y}_{n} )}{{max}_{k ∈ {C}_{j}} {φ}_{k} ( {Y}_{n} )} \}$$

where Cⱼ is the set of indices of competing acoustic-units for the j^{th} acoustic unit.

Software implementing the foregoing methods and system can be stored in the memory of a computer system as a set of instructions to be executed. In addition, the instructions to perform the method and system as described above could alternatively be stored on other forms of machine-readable media, including magnetic and optical disks. For example, the method of the present invention could be stored on machine-readable media, such as magnetic disks or optical disks, which are accessible via a disk drive (or computer-readable medium drive). Further, the instructions can be downloaded into a computing device over a data network in a form of compiled and linked version.

Alternatively, the logic to perform the methods and systems as discussed above, could be implemented in additional computer and/or machine readable media, such as discrete hardware components as large-scale integrated circuits (LSI's), application-specific integrated circuits (ASIC's), or firmware such as electrically erasable programmable read-only memory (EEPROM's); or spatially distant computers relaying information through electrical, optical, acoustical and other forms of propagated signals (e.g., radio waves or infrared optical signals).

Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the invention. The various appearances “an embodiment,” “one embodiment,” or “some embodiments” are not necessarily all referring to the same embodiments.

If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Those skilled in the art having the benefit of this disclosure will appreciate that many other variations from the foregoing description and drawings may be made within the scope of the present invention. Accordingly, it is the following claims including any amendments thereto that define the scope of the invention.

The claimed invention is:

1. A speech processing method comprising:
pre-processing a digital speech signal to reduce noise using a noise mitigation algorithm having defined parameters;
analyzing the digital speech signal with a automatic speech recognition system decoder that provides decoder scores;
determining acoustic-unit confidence given the ASR decoder scores; and
modifying at least one of the noise mitigation algorithm and defined parameters based on the computed acoustic unit confidence.

2. The method of claim 1, wherein the noise mitigation algorithm is changed.

3. The method of claim 1, wherein the defined parameters utilized by the noise mitigation algorithm are changed.

4. The method of claim 3, wherein the defined parameters utilized by the noise mitigation algorithm are adaptively modified.

5. The method of claim 3, wherein the defined parameters utilized by the noise mitigation algorithm are adjusted between sets of pre-defined parameters.

6. The method of claim 1, wherein the ASR decoder is a Viterbi decoder, with the first decoding pass recognizing speech and the second pass obtaining acoustic unit scores used for determining acoustic-unit confidence.

7. The method of claim 1, wherein the ASR decoder further uses an acoustic sampling block.

8. The method of claim 7, wherein the acoustic sampling block selects a subset of acoustic-units.

9. The method of claim 8, wherein the subset of acoustic-units comprises calculation of scores for a correct triphone and a subset of the competing triphones.

10. The method of claim 7, wherein the a subset of the speech model parameters are provided to the ASR decoder in the second decoding step.

11. An article comprising a storage medium having stored thereon instructions that when executed by a machine result in:
pre-processing a digital speech signal to reduce noise using a noise mitigation algorithm having defined parameters;
analyzing the digital speech signal with an ASR decoder that provides decoder scores;
determining acoustic-unit confidence given the ASR decoder scores; and
modifying at least one of the noise mitigation algorithm and defined parameters based on the computed unit confidence.

12. The article comprising a storage medium having stored thereon instructions according to claim 11, wherein the noise mitigation algorithm is changed.

13. The article comprising a storage medium having stored thereon instructions according to claim 11, wherein the defined parameters utilized by the noise mitigation algorithm are changed.

14. The article comprising a storage medium having stored thereon instructions according to claim 11, wherein the defined parameters utilized by the noise mitigation algorithm are adaptively modified.

15. The article comprising a storage medium having stored thereon instructions according to claim 11, wherein the defined parameters utilized by the noise mitigation algorithm are adjusted between sets of pre-defined parameters.

16. The article comprising a storage medium having stored thereon instructions according to claim 11, wherein the Viterbi decoder is a two pass decoder, with the first pass recognizing speech and the second pass obtaining acoustic unit scores used for determining acoustic-unit confidence.

17. The article comprising a storage medium having stored thereon instructions according to claim 11, wherein the ASR decoder further uses an acoustic sampling block.

18. The article comprising a storage medium having stored thereon instructions according to claim 17, wherein the acoustic sampling block selects a subset of acoustic-units.

19. The article comprising a storage medium having stored thereon instructions according to claim 18, wherein the subset of acoustic-units comprises calculation of scores for a correct triphone and a subset of the competing triphones.

20. The article comprising a storage medium having stored thereon instructions according to claim 17, wherein the a subset of the speech model parameters are provided to the ASR decoder in the second decoding step.

21. A speech processing system comprising:
a digital speech signal preprocessor to reduce noise using a noise mitigation algorithm having defined parameters that can be modified based on computed acoustic unit confidence:
an ASR decoder that analyzes the digital speech signal after digital speech signal pre-processing and provides decoder scores; and
a post processing module connected to the ASR decoder and the digital speech signal preprocessor to determine acoustic-unit confidence given the ASR decoder scores.

22. The system of claim 21, wherein the noise mitigation algorithm of the digital speech signal preprocessor is changed.

23. The system of claim 21, wherein the defined parameters utilized by the noise mitigation algorithm are changed.

24. The system of claim 21, wherein the defined parameters utilized by the noise mitigation algorithm are adaptively modified.

25. The system of claim 21, wherein the defined parameters utilized by the noise mitigation algorithm are adjusted between sets of pre-defined parameters.

26. The system of claim 21, wherein the ASR decoder is a Viterbi decoder, with the first decoding step recognizing speech and the second decoding step obtaining acoustic unit scores used for determining acoustic-unit confidence.

27. The system of claim 21, wherein the ASR decoder further uses an acoustic sampling block.

28. The system of claim 27, wherein the acoustic sampling block selects a subset of acoustic-units.

29. The system of claim 28, wherein the subset of acoustic-units comprises calculation of scores for a correct triphone and a subset of the competing triphones.

30. The system of claim 27, wherein a subset of the speech model parameters are provided to the ASR decoder in the second decoding step.
